(19) United States
(12) Patent Application Publication
(10) Pub. No.: US 2021/0131479 A1
(43) Pub. Date: May 6, 2021

(54) RETAINER NUT LOCKING APPARATUS AND METHODS

(71) Applicant: FORUM US, INC., Houston, TX (US)

(72) Inventors: Wesley FREED, Aledo, TX (US); Saul DOMINGUEZ, Mansfield, TX (US)

(21) Appl. No.: 16/670,895

(22) Filed: Oct. 31, 2019

(51) Int. Cl. F16B 39/10; F16B 37/04

(52) U.S. Cl. CPC F16B 39/10; F16L 19/005; F16B 37/045; F16B 37/044

(57) ABSTRACT

Aspects of the present disclosure relate to retainer nut locking apparatus and methods for fluid ends, and associated components thereof. In one implementation, a lock assembly for retainer nuts on fluid ends includes a frame. The frame includes one or more first openings formed therethrough. The lock assembly also includes one or more inserts. Each insert of the one or more inserts is disposed in a first opening of the one or more first openings formed in the frame. The lock assembly also includes one or more insert retainers each having a locking tab protruding into one of one or more slots of each insert to limit rotation of the insert about a longitudinal axis of the insert. The one or more insert retainers are fastened to the frame.

### BACKGROUND

### Field

The disclosure relates to retainer nut locking apparatus and methods for fluid ends, and associated components thereof.

### Description of the Related Art

Retainer nuts are used in the oil and gas industry, such as on fluid ends. Operational problems can arise when the retainer nuts back out during use. For example, backing out of a retainer nut can cause premature failure of a fluid end by causing cracking in the fluid end. The probability or extent of such a failure can cause changes to be made to the fluid end that increase cost and complexity of the fluid end, and/or decrease reliability, ease of use, and/or modularity of the fluid end.

Therefore, there is a need for an apparatus that reduces or eliminates the risk and/or amount of retainer nuts backing out during use, and promotes reliability, cost-effectiveness, design simplicity, ease of use, and modularity of fluid ends.

### SUMMARY

Aspects of the present disclosure relate to retainer nut locking apparatus and methods for fluid ends, and associated components thereof.

In one implementation, a lock assembly for retainer nuts on fluid ends includes a frame. The frame includes one or more first openings formed therethrough. The lock assembly also includes one or more inserts. Each insert of the one or more inserts is disposed in a first opening of the one or more first openings formed in the frame. The lock assembly also includes one or more insert retainers each having a locking tab protruding into one of one or more slots of each insert to limit rotation of the insert about a longitudinal axis of the insert. The one or more insert retainers are fastened to the frame.

In one implementation, a fluid end includes a fluid end body. The fluid end body includes an outer surface. The fluid end includes a plunger disposed at least partially in the fluid end body, a bore formed in the fluid end body, and a retainer nut disposed at least partially in the bore. The retainer nut includes an inner tool interface. The fluid end also includes a lock assembly. The lock assembly includes a frame. The frame includes a first opening formed therethrough. The lock assembly also includes an insert disposed in the first opening formed in the frame and into the inner tool interface of the retainer nut. The lock assembly also includes an insert retainer having a locking tab protruding into a slot of the insert to limit rotation of the insert about a longitudinal axis of the insert. The insert retainer is fastened to the frame.

In one implementation, a method of installing a lock assembly to a fluid end includes providing a frame having a first opening formed therethrough. The method also includes disposing an insert into the first opening of the frame. The insert has a first slot and a second slot. The method also includes fastening a first insert retainer to the frame and at least partially around the insert. The fastening of the first insert retainer to the frame includes inserting a locking tab of the first insert retainer into the first slot of the insert. The method also includes fastening a second insert retainer to the frame and at least partially around the insert. The fastening of the second insert retainer to the frame includes inserting a locking tab of the second insert retainer into the second slot of the insert. The method also includes inserting the insert into an inner tool interface of a retainer nut disposed in a fluid end body of the fluid end.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A is a schematic isometric view of a fluid end having a fluid end body, according to one implementation.

FIG. 1B is a schematic isometric view of the locking assembly illustrated in FIG. 1A, according to one implementation.

FIG. 1C is a schematic isometric view of an insert of the inserts illustrated in FIGS. 1A and 1B, according to one implementation.

FIG. 1D is a schematic isometric view of an insert retainer of the insert retainers illustrated in FIGS. 1A-1C, according to one implementation.

FIG. 1E is a schematic front view of the lock assembly illustrated in FIGS. 1A and 1B, according to one implementation.

FIG. 2A is a schematic cross-sectional view of the fluid end illustrated in FIG. 1A along lines A-A, according to one implementation.

FIG. 2B is a schematic cross-sectional view of the fluid end illustrated in FIG. 1A along lines B-B, according to one implementation.

FIG. 3 is a schematic illustration of a method of installing a lock assembly to a fluid end, according to one implementation.

To facilitate understanding, identical reference numerals have been used, where possible, to designate identical elements that are common to the figures. It is contemplated that elements disclosed in one implementation may be beneficially utilized on other implementations without specific recitation.

### DETAILED DESCRIPTION

Aspects of the present disclosure relate to retainer nut locking apparatus and methods for fluid ends, and associated components thereof.

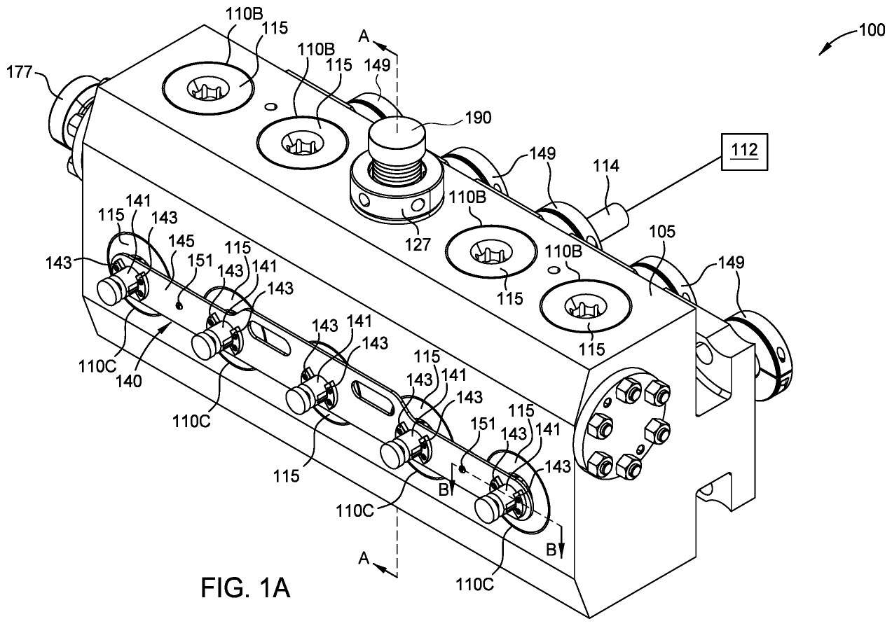

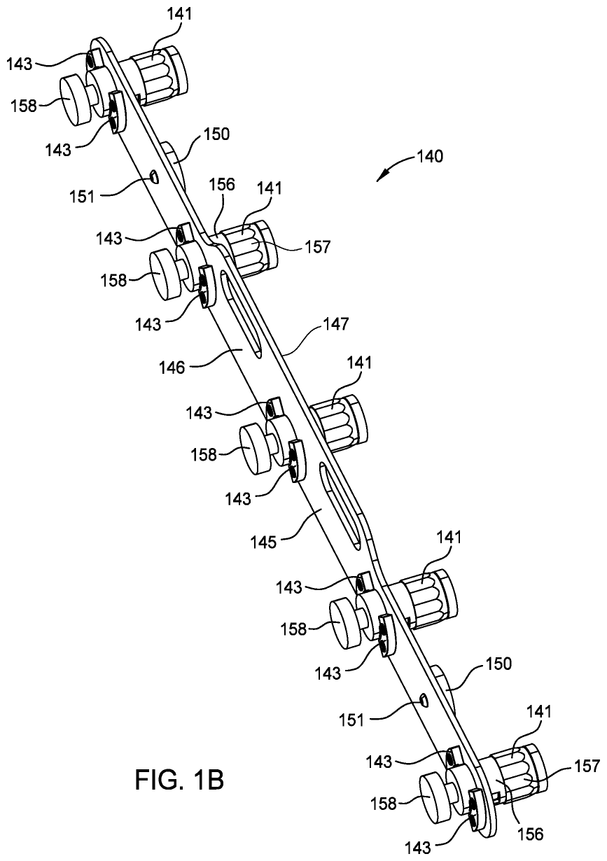

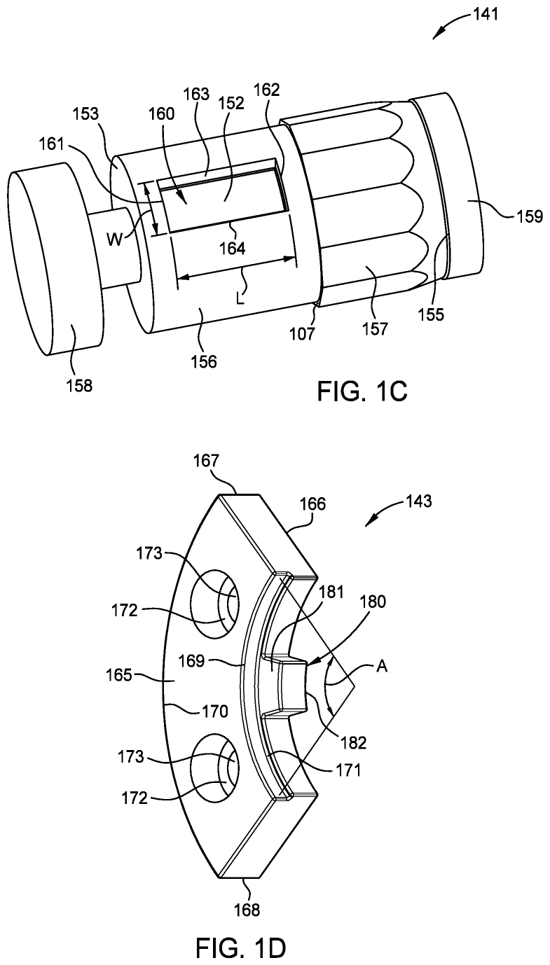

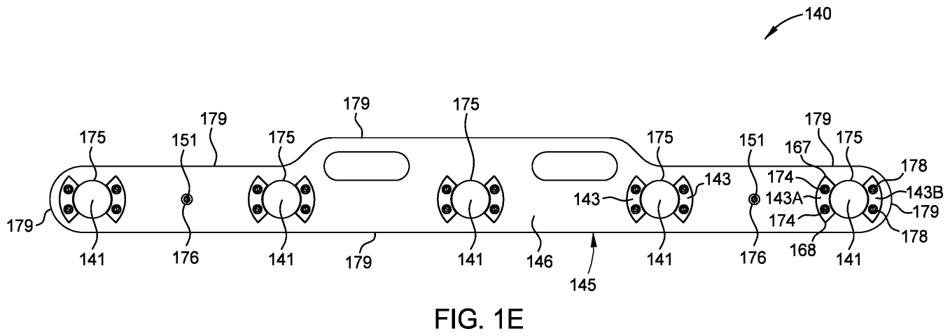

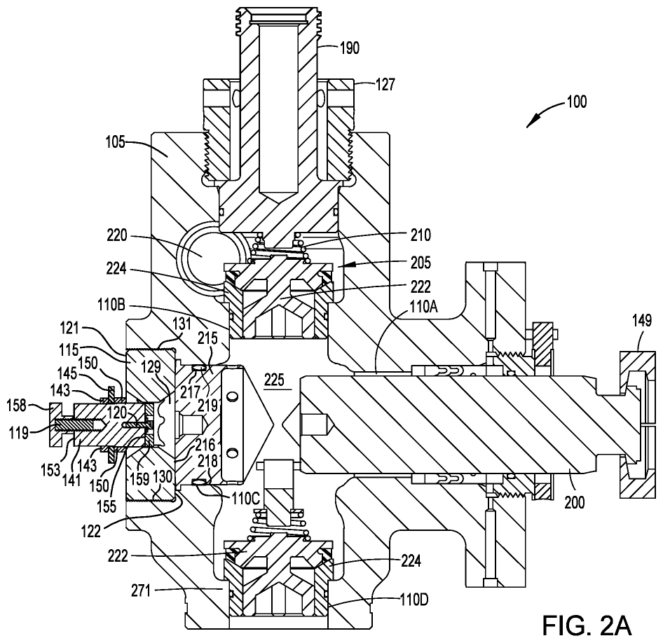

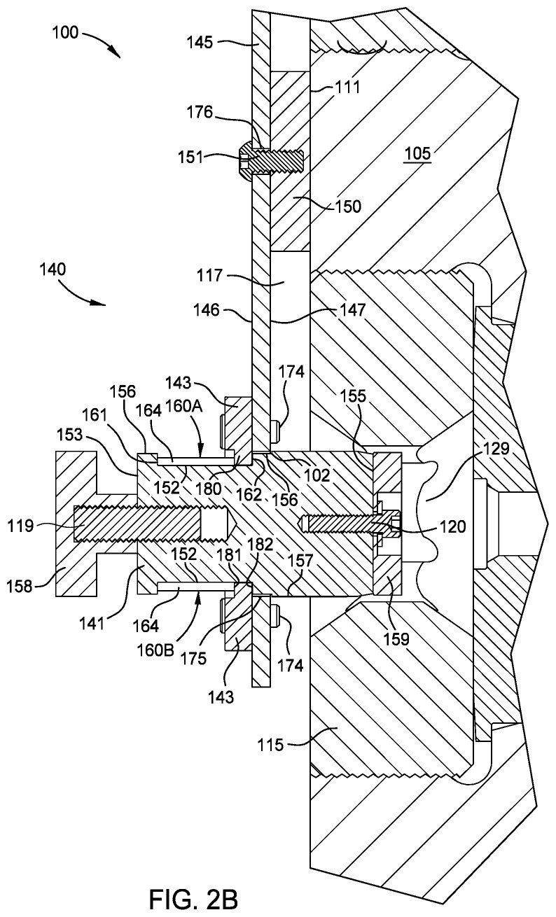

FIG. 1A is a schematic isometric view of a fluid end 100 having a fluid end body 105, according to one implementation. The fluid end 100 includes a plurality of bores 110A-110D formed in the fluid end body 105. Bores 110A and 110D are on the back side and bottom of the fluid end 100 and are shown FIG. 2A. The fluid end 100 is adapted to couple to a power end 112 via a pony rod 114. While only one pony rod 114 is shown, the power end 112 may have a pony rod that couples to each of the bores 110A of the fluid end 100.

The present disclosure contemplates that terms such as “couples,” “coupling,” “couple,” and “coupled” may include welding and/or fastening such as by using bolts, threaded studs, and/or screws.

The fluid end 100 includes retainer nuts 115. Each of the retainer nuts 115 is disposed at least partially in one of the bores 110C. The fluid end 100 also includes a retainer nut 115 disposed in each of the bores 110B. Each of the bores 110B may include a retainer nut 115 disposed at least partially therein that includes one or more of the same features, aspects, components, and/or properties as the retainer nuts 115 disposed at least partially in the bores 110C.

A gauge connector 190 may be coupled to one of the bores 110B by a gauge connector nut 127. A discharge flange 177 may be coupled to opposing ends of the fluid end body 105 for connecting hoses with a discharge manifold. A plunger clamp 149 may be disposed between the fluid end 100 and the pony rod 114.

The fluid end 100 includes a lock assembly 140. The lock assembly 140 includes one or more inserts 141 (a plurality of inserts 141 is illustrated). The lock assembly 140 includes a frame 145. In one example, the frame 145 is a plate. In one example, the frame 145 includes a piece of sheet metal. The lock assembly 140 includes one or more insert retainers 143 (a plurality of insert retainers 143 is illustrated). A pair of insert retainers 143 is disposed at least partially around each insert 141. The inserts 141 are disposed through the frame 145 and at least partially into the retainer nuts 115 disposed in the fluid end body 105.

FIG. 1B is a schematic isometric view of the locking assembly 140 illustrated in FIG. 1A, according to one implementation. The frame 145 includes an outward surface 146 and an inward surface 147. The lock assembly 140 includes one or more magnets 150 coupled to the inward surface 147 of the frame 145 using one or more fasteners 151 (such as one or more screws, threaded studs, and/or bolts) disposed through the frame 145.

The present disclosure contemplates that “inward,” inwards,” and “inwardly” includes “inward,” “inwards,” or “inwardly” relative to the fluid end body 105, such as relative to a center of the fluid end body 105.

The present disclosure contemplates that “outward,” outwards,” and “outwardly” includes “outward,” “outwards,” or “outwardly” relative to the fluid end body 105, such as relative to a center of the fluid end body 105.

FIG. 1C is a schematic isometric view of an insert 141 of the inserts 141 illustrated in FIGS. 1A and 1B, according to one implementation. The insert 141 includes an outward end 153 and an inward end 155. The insert 141 is cylindrical. The insert includes a first outer surface 156 and a second outer surface 157. The first outer surface 156 is smooth and the second outer surface 157 is hex in shape, such as the shape of a hex tool, for example a hex wrench. The insert 141 includes a handle 158 coupled to the outward end 153 and a magnet 159 coupled to the inward end 155. The handle 158 facilitates positioning and rotating the insert 141, such as positioning and rotating the insert 141 into position in the frame 145 and one of the retainer nuts 115 illustrated in FIG. 1A. The handle 158 may be manipulated by the hand of a user, for example.

The second outer surface 157 is disposed radially outside of the first outer surface 156 such that a shoulder 107. The shoulder 107 protrudes radially outwards from the first outer surface 156 of the insert 141.

The insert 141 includes one or more slots 160 formed in the first outer surface 156 of the insert 141. Each slot 160 defines an outward lip 161, an inward lip 162 of the insert 141, a first sidewall 163, a second sidewall 164, and a recessed surface 152. The outward lip 161 and the inward lip 162 are separated by a slot length L that is larger than a slot width W. The slots 160 of the insert 141 are disposed equidistantly about a circumference of the first outer surface 156, such as a first slot 160A and a second slot 160B disposed about 180 degrees apart about the circumference of the first outer surface (as illustrated in FIG. 2B).

FIG. 1D is a schematic isometric view of an insert retainer 143 of the insert retainers 143 illustrated in FIGS. 1A-1C, according to one implementation. The insert retainer 143 is arcuate in shape. The insert retainer 143 includes an outward surface 165 and an inward surface 166. The insert retainer 143 includes a top end 167 and a bottom end 168. The top end 167 is disposed above the insert 141 and a bottom end 168 disposed below the insert 141 (as illustrated in FIGS. 1A-1C and 1E). The insert retainer 143 includes an angle A defined between the top end 167 and the bottom end 168 that spans the insert retainer 143. The angle A is less than 180 degrees, such as about 90 degrees.

The insert retainer 143 includes an inner curvature 169 and an outer curvature 170. The insert retainer 143 includes a curved shoulder 171 protruding from the inner curvature 169. The insert retainer 143 includes a locking tab 180 protruding from the inner curvature 169 and past the curved shoulder 171. The locking tab 180 includes an inward surface 182 and an outward surface 181. The insert retainer 143 includes recesses 172 formed in the outward surface 165 of the insert retainer 143, and openings 173. The recesses 172 and the openings 173 receive fasteners 174 (illustrated in FIG. 1E) such as screws, threaded studs, and/or bolts that fasten the insert retainer 143 to the frame 145.

FIG. 1E is a schematic front view of the lock assembly 140 illustrated in FIGS. 1A and 1B, according to one implementation. The frame 145 includes one or more first openings 175 (a plurality of first openings 175 is illustrated) formed through the frame 145 from the outward surface 146 to the inward surface 147. The frame 145 includes one or more second openings 176 (a plurality of second openings 176 is illustrated) formed through the frame 145 from the outward surface 146 to the inward surface 147. The one or more fasteners 151 (such as one or more screws, threaded studs, and/or bolts) are disposed through the second openings 176 to fasten the magnets 150 (illustrated in FIG. 1B) to the inward surface 147 of the frame 145. The frame 145 includes one or more third openings 178 (a plurality of third openings 178 is illustrated) formed through the frame 145 from the outward surface 146 to the inward surface 147. One or more fasteners 174 (such as one or more screws, threaded studs, and/or bolts) are disposed through the third openings 178 to fasten the insert retainers 143 (such as a first insert retainer 143A and a second insert retainer 143B) to the outward surface 146 of the frame 145.

A pair of insert retainers 143, such as the first insert retainer 143A and the second insert retainer 143B, are disposed at least partially around each insert 141 and each first opening 175 that includes an insert 141 disposed therethrough. The first insert retainer 143A is disposed at least partially around the insert 141 on a first side of the insert 141 and the second insert retainer 143B is disposed at least partially around the insert 141 on a second side of the insert 141. An outer perimeter 179 of the frame 145 surrounds and is disposed outside of the insert retainers 143, the first openings 175, and the inserts 141. The first outer surface 156 is partially disposed in one of the first openings 175 of the frame (as illustrated in FIG. 1B).

FIG. 2A is a schematic cross-sectional view of the fluid end 100 illustrated in FIG. 1A along lines A-A, according to one implementation. Referring to FIG. 2A, the internal components of the fluid end 100 will be described. A plunger 200 is shown disposed in the bore 110A and a valve assembly 205 having a spring 210 is shown disposed in the bore 110B. A suction cover 215 is shown disposed in the bore 110C and a valve stop 271 is shown in the bore 110D. The suction cover 215 is disposed inwards of the retainer nut 115 relative to the fluid end body 105. A valve body 222 as well as a valve seat 224 may also be disposed in the bores 110B and 110D. The fluid end body 105 may also include a discharge manifold 220 formed therein that is in selective communication with at least the bore 110B. The bores 110A-110D formed in the fluid end body 105 intersect within the fluid end body 105 at a junction 225.

The retainer nut 115 includes a first surface 121 at a first end of the retainer nut 115 and a second surface 122 at a second end of the retainer nut 115. The second surface 122 is disposed inwardly of the first surface 121. The first surface 121 faces away from the fluid end body 105 and the second surface 122 faces the fluid end body 105. The retainer nut 115 is installed in the bore 110C of the fluid end body 105 such that the second surface 122 contacts a first surface 216 of the suction cover 215. The suction cover 215 includes a recess 217 formed in an outer surface 218 of the suction cover 215. A seal 219 is disposed in the recess 217 of the suction cover 215. The retainer nut 115 is threaded into the bore 110C of the fluid end body 105. The retainer nut 115 includes an inner tool interface 129 and a threaded outer surface 130. The inner tool interface 129 is sized and shaped to be removed by a tool, such as a wrench or a hex tool, for example when the tool turns the retainer nut 115 to install or remove the retainer nut 115. The threaded outer surface 130 interfaces with, and is threaded into, a threaded portion 131 of an inner surface of the fluid end body 105. The inner surface is defined at least partially by the bore 110C.

The handle 158 is coupled to the insert 141 at the outward end 153 using one or more fasteners 119, such as one or more bolts, screws, and/or threaded studs. The magnet 159 is coupled to the insert 141 at the inward end 155 using one or more fasteners 120, such as one or more bolts, screws, and/or threaded studs. The insert 141 includes one or more openings at the outward end 153 and the inward end 155 to receive the one or more fasteners 119 and the one or more fasteners 120.

FIG. 2B is a schematic cross-sectional view of the fluid end 100 illustrated in FIG. 1A along lines B-B, according to one implementation. The magnet 150 fastened to the inward surface 147 of the frame 145 is disposed between the inward surface 147 of the frame 145 and the outer surface 111 of the fluid end body 105. A gap 117 is disposed between the inward surface 147 of the frame 145 and the outer surface 111 of the fluid end body 105.

The insert 141 includes a first slot 160A and a second slot 160B disposed opposite of the first slot 160A. Each of the first slot 160A and the second slot 160B includes the outward lip 161, the inward lip 162, the first sidewall 163 (illustrated in FIG. 1C), the second sidewall 164, and the recessed surface 152. Each insert retainer 143 of the insert retainers 143 includes the locking tab 180 having the outward surface 181 and the inward surface 182. Each locking tab 180 protrudes into one of the first slot 160A or the second slot 160B. Each of the locking tabs 180 is movable relative to the insert 141 between the inward lip 162 and the outward lip 161 of the respective slot 160A or 160B. The locking tabs 180 are movable relative to the insert 141 by moving the frame 145 and the insert retainers 143 and/or by moving the insert 141. The inward surfaces 182 of the locking tabs 180 are in contact with the inwards lips 162 of the first and second slots 160A, 160B. Moving the locking tabs 180 outwardly relative to the insert 141 moves the inward surfaces 182 out of contact from the inward lips 162. Continuing to move the locking tabs 180 outwardly relative to the insert 141 moves the outward surfaces 181 into contact with the outward lips 161 of the first and second slots 160A, 160B. In one example, the shoulder 102 is in contact with the inward surface 147 of the frame 145. Moving the insert retainers 143 and the frame 145 outwardly relative to insert 141 moves the shoulder 102 out of contact from the inward surface 147 of the frame 145.

The insert 141 is disposed through the frame 145 in the first opening 175 and at least partially into the inner tool interface 129 of the retainer nut 115.

The locking tabs 180 protruding into the slots 160 facilitates preventing the retainer nuts 115 from backing out from the fluid end body 105 by facilitating preventing the retainer nuts 115 from rotating. For example, as the retainer nuts 115 attempt to rotate out from the fluid end body 105, the locking tabs 180 contact one or more of the first sidewall 163 and/or the second sidewall 164 defined by the slots 160 of the insert 141, thereby preventing the retainer nuts 115 from continuing to rotate. The engagement between the locking tabs 180 of the insert retainers 143 and the slots 160 of the insert retainers 143 limits the amount that each insert 141 can rotate about a longitudinal axis of the insert 141, which thereby prevents the retainer nuts 115 from rotating and backing out of the fluid end body 105.

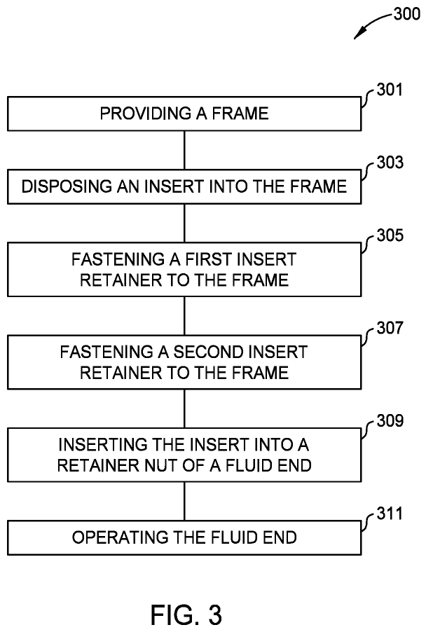

FIG. 3 is a schematic illustration of a method 300 of installing a lock assembly 140 to a fluid end 100, according to one implementation. The method 300 includes, at block 301, providing a frame 145 having a first opening 175 formed therethrough. Block 303 includes disposing an insert 141 into the first opening 175 of the frame 145. The insert 141 is disposed into the first opening 175 in a direction from an inward surface 147 to an outward surface 146 of the frame 145. The insert has a first slot 160A and a second slot 160B. Block 305 includes fastening a first insert retainer 143A to the frame 145 and at least partially around the insert 141. The fastening the first insert retainer 143A to the frame 145 at block 305 includes inserting a locking tab 180 of the first insert retainer 143A into the first slot 160A of the insert 141. Block 305 also includes fastening the first insert retainer 143A to the frame 145 using fasteners 174, such as one or more screws, threaded studs, and/or bolts.

Block 307 includes fastening a second insert retainer 143B to the frame 145 and at least partially around the insert 141. The fastening the second insert retainer 143B to the frame 145 includes inserting a locking tab 180 of the second insert retainer 143B into the second slot 160B of the insert 141. Block 307 also includes fastening the second insert retainer 143B to the frame 145 using fasteners 174. Block 309 includes inserting the insert 141 into an inner tool interface 129 of a retainer nut 115 disposed in a fluid end body 105 of the fluid end 100. The insert 141 is inserted into the retainer nut 115 after the first insert retainer 143A and the second insert retainer 143B are fastened to the frame 145.

Block 311 includes operating the fluid end 100. In one example, operating the fluid end 100 includes using the fluid end 100 as part of a pump having a power end. The pump is a reciprocal pump. Operating the pump includes pumping frac fluids downhole during oil and gas operations.

Benefits of the present disclosure include reduced or eliminated probability of premature failure of fluid ends; reduced or eliminated probability of backing out of retainer nuts; ease of use of fluid ends and a lock assembly for retainer nuts; ease of visual reference of a lock assembly; reduced or eliminated probability of users breaking locking components; promoted modularity of fluid ends with a lock assembly; reduced or eliminated changes to fluid ends; ease of use of fluid ends and a lock assembly; low costs for fluid ends and lock assemblies; and promoted reliability of fluid ends and lock assemblies.

Aspects of the present disclosure include a lock assembly, a frame having openings, inserts having slots and disposed through the frame and into retainer nuts, insert retainers fastened to the frame, insert retainers disposed at least partially around the inserts, locking tabs protruding from insert retainers, magnets between a frame and a fluid end body, magnets as part of the inserts, and a method of installing a lock assembly to a fluid end.

It is contemplated that one or more of these aspects disclosed herein may be combined. Moreover, it is contemplated that one or more of these aspects may include some or all of the aforementioned benefits.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The present disclosure also contemplates that one or more aspects of the embodiments described herein may be substituted in for one or more of the other aspects described. The scope of the disclosure is determined by the claims that follow.

We claim:

1. A lock assembly for retainer nuts on fluid ends, comprising:
a frame, the frame comprising one or more first openings formed therethrough;
one or more inserts, each insert of the one or more inserts being disposed in a first opening of the one or more first openings formed in the frame; and
one or more insert retainers each having a locking tab protruding into one of one or more slots of each insert to limit rotation of the insert about a longitudinal axis of the insert, the one or more insert retainers being fastened to the frame.

2. The lock assembly of claim 1, wherein each insert of the one or more inserts is cylindrical and comprises one or more slots, each slot of the one or more slots having an inward lip and an outward lip.

3. The lock assembly of claim 2, wherein the locking tab is movable relative to the insert between the inward lip and the outward lip of the slot.

4. The lock assembly of claim 3, wherein the locking tab comprises an inward surface and an outward surface, and the inward surface is in contact with the inward lip of the slot.

5. The lock assembly of claim 4, wherein each insert retainer of the one or more insert retainers is arcuate in shape and comprises a top end above the insert and a bottom end below the insert.

6. The lock assembly of claim 2, wherein:
each insert of the one or more inserts comprises a first outer surface and a second outer surface disposed inwardly of the first outer surface;
each slot of the one or more slots is formed in the first outer surface; and
the second outer surface is hex in shape.

7. The lock assembly of claim 6, wherein the first outer surface of each insert of the one or more inserts is disposed in a first opening of the one or more first openings, and each insert retainer of the one or more insert retainers partially surrounds the first outer surface.

8. The lock assembly of claim 1, wherein each insert of the one or more inserts comprises an inward end, an outward end, and a magnet coupled to the inward end.

9. The lock assembly of claim 8, further comprising a handle coupled to the outward end of each insert of the one or more inserts.

10. The lock assembly of claim 8, wherein the frame comprises one or more second openings formed therethrough, and a magnet coupled to the frame through each second opening of the one or more second openings.

11. A fluid end, comprising:
a fluid end body, the fluid end body comprising an outer surface;
a plunger disposed at least partially in the fluid end body;
a bore formed in the fluid end body;
a retainer nut disposed at least partially in the bore, the retainer nut comprising
an inner tool interface; and
a lock assembly, comprising:
a frame, the frame comprising a first opening formed therethrough,
an insert disposed in the first opening formed in the frame and into the inner tool interface of the retainer nut,
an insert retainer having a locking tab protruding into a slot of the insert to limit rotation of the insert about a longitudinal axis of the insert, the insert retainer being fastened to the frame.

12. The fluid end of claim 11, wherein:
the insert is cylindrical and comprises a slot, the slot comprising an inward lip and an outward lip;
the insert retainer comprises a locking tab protruding into the slot; and
the locking tab of each of the insert retainer is movable relative to the insert between the inward lip and the outward lip of the slot.

13. The fluid end of claim 12, wherein the locking tab of the insert retainer comprises an inward surface and an outward surface, and the inward surface is in contact with the inward lip of the slot.

14. The fluid end of claim 13, wherein the insert retainer is arcuate in shape and comprises a top end above the insert and a bottom end below the insert.

15. The fluid end of claim 12, wherein:
the insert comprises a first outer surface and a second outer surface disposed inwardly of the first outer surface;
the slot is formed in the first outer surface; and
the second outer surface is hex in shape.

16. The fluid end of claim 15, wherein the first outer surface of the insert is disposed in the first opening, and the insert retainer partially surrounds the first outer surface.

17. The fluid end of claim 11, wherein:
the insert comprises an inward end, an outward end, and a magnet coupled to the inward end; and
the frame comprises a second opening formed therethrough, and a magnet coupled to the frame through the second opening.

18. The fluid end of claim 17, further comprising a handle coupled to the outward end of the insert.

19. The fluid end of claim 17, wherein the frame comprises an outward surface and an inward surface, the insert retainer is fastened to the outward surface, and the magnet coupled to the frame is disposed between the inward surface of the frame and the outer surface of the fluid end body such that the inward surface is disposed at a gap from the outer surface of the fluid end body.

20. A method of installing a lock assembly to a fluid end, comprising:
providing a frame having a first opening formed therethrough;
disposing an insert into the first opening of the frame, the insert having a first slot and a second slot;
fastening a first insert retainer to the frame and at least partially around the insert, the fastening the first insert retainer to the frame comprising:
inserting a locking tab of the first insert retainer into the first slot of the insert;
fastening a second insert retainer to the frame and at least partially around the insert, the fastening the second insert retainer to the frame comprising:
inserting a locking tab of the second insert retainer into the second slot of the insert; and
inserting the insert into an inner tool interface of a retainer nut disposed in a fluid end body of the fluid end.
